(19) United States
(12) Patent Application Publication
(10) Pub. No.: US 2023/0105138 A1
(43) Pub. Date: Apr. 6, 2023

(54) DETECTING, ANALYZING, AND REPORTING TRANSACTION BOTTLENECKS

(71) Applicant: NCR Corporation, Atlanta, GA (US)

(72) Inventors: Itamar David Laserson, Givat Shmuel (IL); Roee Ben Shlomo, Moshav Benaya (IL); Amit Botzer, Haifa (IL); Shay Marom, Kiryat Tiv’on (IL)

(21) Appl. No.: 17/489,930

(22) Filed: Sep. 30, 2021

(51) Int. Cl. G06Q 20/20; G06Q 10/10; G06N 20/00

(52) U.S. Cl. CPC G06Q 20/202; G06N 20/00; G06Q 10/1091

(57) ABSTRACT

Average processing times associated with components of a transactions are maintained as performance metrics for the transactions. Ratios associated with the average processing times are normalized based on calendar dates, days of week, and times of day. A given transaction is analyzed in view of the averages and ratios and a bottleneck is identified within a time slice of the given transaction. A type of bottleneck detected within the time slice is further identified based on identifiers associated with resources of the time slice and a pattern associated with one or more of the identifiers. The transaction, time slice, type of bottleneck, and resource identifiers are reported to a retailer associated with a transaction terminal that processed the transaction through an interface.

### BACKGROUND

One of the toughest challenges for retail store operations is to streamline and remove friction from the checkout process. Bottlenecks at the Point-Of-Sale (POS) terminals and Self-Checkouts (SCOs or Self-Service Terminals (SSTs)) are substantial overhead to the store labor hours, which reduce cashier efficiency but more importantly, increase the length of customer lines in checkout queues along with customer frustrations with the store.

1 % of the checkout process can account for 10% of a cashier’s time during any given checkout. These type of transactions take longer than is expected due to bottlenecks, which if known to the retailer can be resolved by proper cashier training, technology deployment, engagement with suppliers, and other solutions. The nature or root cause of the bottlenecks are constantly changing, and stores use ad-hoc analysis and reporting to identify and resolve them. Often the ability to effectively and timely report the bottlenecks is beyond the technological capabilities of the retailer.

If stores could eliminate these bottlenecks and bring transactions associated with the bottlenecks in line with transaction processing times associated with normal non-bottleneck transactions, an average-size retailer could save 15,000 staff hours per year, which translates to approximately $255 thousand dollars in savings or more than $600 thousand dollars in savings for a retailer having at least 100 retail stores.

Thus, retailers need technology to quickly identify bottlenecks during a transaction checkout and timely report the bottlenecks for resolution.

### SUMMARY

In various embodiments, system and a method for detecting, analyzing, and reporting transaction bottlenecks are presented.

According to an aspect, a method for detecting, analyzing, and reporting transaction bottlenecks is presented. Average transaction processing times are maintained based on sizes of transactions and ratios of the sizes to the average transaction processing times and maintained. A deviation from a given ratio in a time slice of a given transaction is identified and the given transaction is flagged as a problem transaction. A pattern associated with select resource identifiers is detected within the time slice and the pattern is assigned to a bottleneck associated with the time slice. A record is maintained for the given transaction, the pattern, the select resource identifiers, and the time slice for reporting the bottleneck.

### BRIEF DESCRIPTION OF THE DRAWINGS

FIG. 1 is a diagram of a system for detecting, analyzing, and reporting transaction bottlenecks, according to an example embodiment.

FIG. 2 is a diagram of a method for detecting, analyzing, and reporting transaction bottlenecks, according to an example embodiment.

FIG. 3 is a diagram of another method for detecting, analyzing, and reporting transaction bottlenecks, according to an example embodiment.

### DETAILED DESCRIPTION

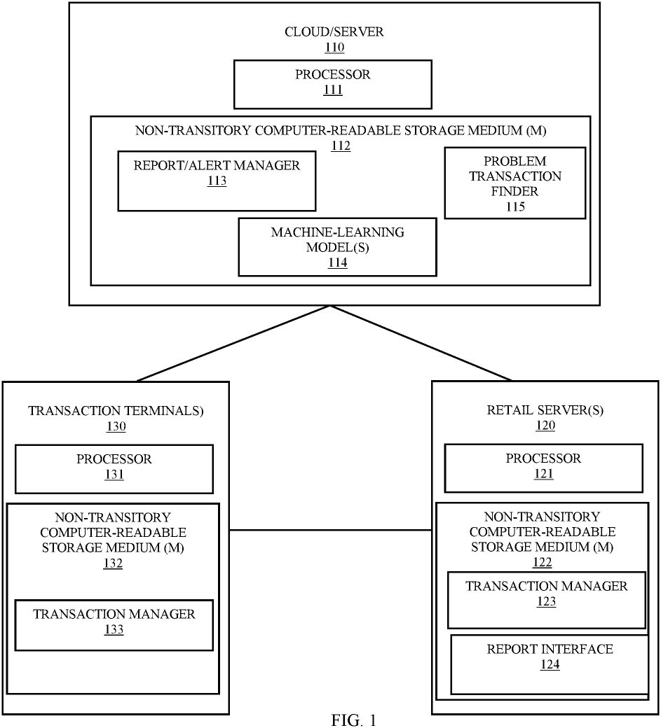

FIG. 1 is a diagram of a system 100 for detecting, analyzing, and reporting transaction bottlenecks, according to an example embodiment. It is to be noted that the components are shown schematically in greatly simplified form, with only those components relevant to understanding of the embodiments being illustrated.

Furthermore, the various components (that are identified in FIG. 1) are illustrated and the arrangement of the components is presented for purposes of illustration only. It is to be noted that other arrangements with more or less components are possible without departing from the teachings of detecting, analyzing, and reporting transaction bottlenecks presented herein and below.

The techniques presented herein and below are based on detection of unproportional ratios between a given transaction’s size (number of total items in the transaction) and the relative percentage of time spend on those transactions. A metric points out “where” and “when” an unjustified long processing time is associated with a given transaction. After detecting the where and the when, and an advanced feature selection-based algorithm is processed that targets time windows in which an unjustified long transaction took place and diagnoses the root cause of the bottleneck to interoperate he root cause of that bottleneck. The model is based on statistical testing for all parameters with consideration and normalization by the day associated with the transaction, the hour (rush hour sales is different than end-of-day sales), statistics associated with the given touchpoint of the transaction, and relative items for comparison properties. An output is produced as a list of bottlenecks which is presented to the retailer with reference to the time, place (the store), relevant transactions, the reason, and an estimated time and money wasted due to the bottleneck. The retailer can then read this information or receive an alert in real time for purposes of preventing repetitions of the same bottleneck occurring at the store and to dynamically adjusts store efficiencies and therefore store income.

System 100 comprises a cloud/server 110, a plurality of transaction terminals 130, and one or more retail servers 120.

Cloud/Server 110 comprises at least one processor 111 and a non-transitory computer-readable storage medium 112. Medium 112 comprises executable instructions for report/alert manager 113, one or more machine-learning models (algorithms) 114, and a problem transaction finder 115. The executable instructions when executed by processor 111 from the medium 112 cause processor 111 to perform operations discussed herein and below with report/alert manager 113, model(s) 114, and problem transaction finder 114.

Each transaction terminal 120 comprises a processor 121 and a non-transitory computer-readable storage medium 122. Medium 122 comprises executable instructions for a transaction manager 123. The executable instructions when executed by processor 121 from medium 122 cause processor 121 to perform operations discussed herein and below with respect to transaction manager 123.

Each retail server 130 comprises a processor 131 and a non-transitory computer-readable storage medium 132. Medium 132 comprises executable instructions for a transaction manager 133 and report interface 134. The executable instructions when executed by processor 131 from medium 132 cause processor 131 to perform operations discussed herein and below with respect to transaction manager 133 and report interface 134.

Initially, transaction data comprising time-stamped, resource-stamped (device identifiers), cashier-stamped (cashier identifiers), transaction details (item codes, item prices, item descriptions, item quantities, item weights, total number of items, entry method per item (scanned, tapped, manually entered), etc.) for transaction records are obtained by problem transaction finder 115 through report interface 124 and/or through a transaction data store associated with a given retailer of retail server 120.

Problem transaction finder 115 compiles a variety of metrics from the transaction data such as average time per transaction item required to identify a first item in the transaction after the transaction start time or after previous item is recorded to identify a next item in the transaction, average time required to process transactions associated with a small number of total items (small baskets and based on a predefined number of items in a small basket size), average time required to process transactions associate with a medium number of total items (medium baskets and based on a second predefined number of items in a medium basket size), average time required to process transactions associated with a large number of total items (large baskets and based on a third predefined number of items in a large basket size), average time required for processing a specific payment tender type (cash, debit, check, credit card, gift card, etc.), average time required to redeem a specific type of coupon, average amount of time required to clear an interrupt raised by terminal 130 by type (such as customer identification for birthdate verification, price check of an item, security audit, etc.), and any of the above averages per day of week, per time of day, per calendar date, per terminal 130, per store, etc.

Once the problem transaction finder 115 has calculated the model averages on an initial set of transaction data provided by the retailer, ratios for the small, medium, and large basket sizes relative to the corresponding average transaction time associated with the small, medium, and large baskets. For example, a basket size of 30 items (large basket item) is associated with an average transaction time of 10 minutes and therefore has a ratio of 30/10 or 3 items per minute. A basket size of 20 items (medium basket) is associated with an average transaction time of 5 minutes and therefore has a ratio of 20/5 or 4 items per minute. A basket size of 5 items (small basket) is associated with an average transaction time of 1 minute and therefore has a ratio of 5/1 or 5 items per minute.

Since average processing time can vary by calendar day, day of week, and time of day, the ratios are adjusted or normalized based on a given transaction’s calendar date, day of week, and time of day.

Problem transaction finder 115 continuously updates these average times and ratios as new transaction data is received and processed by transaction manager 133 and transaction manager 123. Thus, the model metrics and computed and normalized ratios are current at any given point in time.

The initial set may then be analyzed for past bottleneck transactions on the basis of a given transaction of a given basket size deviating from the normalized ratio by more than a threshold amount. For example, a large basket ration of 3 items processed per minute is associated with 2.5 or 2 items per minute. These records are kicked out or flagged as potential bottleneck transactions for further evaluation. Each transaction record flagged is analyzed to identify what time slice in the transaction between identification of two items, during payment, during clearing of an interrupt did that transaction deviate from the average time expected. These problem time slices are the points within the transaction that are likely associated with a bottleneck. Next the transaction identifier for the problem transaction is recorded along with the problem time slice within the transaction’s time line, and the item identifiers for the items processed in the time slice are recorded, a cashier identifier for the cashier associated with the transaction is recorded, a terminal identifier for the terminal associated with the transaction is recorded, and the amount of deviation from the average and normalized expected ratio in that time slice is recorded.

Once the initial transaction data is processed, problem records are identified with the recorded information discussed above. Patterns are detected in the problem records based on frequencies with which specific unique item identifiers, unique terminal identifiers, and/or unique cashier identifiers appear in the problem records. Each pattern’s frequency is sorted from most frequent to least frequent. When the frequency is above a threshold frequency it is deemed to be associated with a bottleneck that is costing the retailer time and money and such transaction records are flagged as bottlenecks.

The bottlenecks may reveal a lot of specific and useful information to the retailer, such as a specific terminal seems to be a problem, which may indicate that its user-interface touchpoint (touch display, scanner, keyboard) is malfunctioning of too slow in responding during transactions, such that the information technology or tech support needs to be called to evaluate the performance and issues with the touchpoint.

As another example, a specific item code appears to be a problem, which may indicate that the location of the quality of the item code on the corresponding item is causing the problem and the item should be inspected and the vendor/manufacturer of the item contacted to revise the item code’s location on the item or the store should relabel the item during stocking with a duplicate item code of better quality or positioned on the item in a different location than the original vendor/manufacturer location .

As another example, specific item codes and specific cashier identifiers appear to be a problem, which may indicate that these cashiers are having trouble looking up or remembering the item codes associated with these items during checkout and they should keep a cheat sheet with them or undergo training to resolve.

In still another example, specific tender types and/or coupons appear to be a problem, which may indicate that cashiers or software associated with processing these tender types and/or coupons are a problem, such that a software vendor should be contacted to fix the issue, or the cashiers require training on the specific tender types and/or coupons.

It is noted that a single transaction can include multiple identified bottlenecks.

The specific problem transactions identify “where” bottlenecks were detected while the time slices within those problem represents the “when” a bottleneck occurred in a given problem transaction. Each flagged pattern (based on a threshold frequency of occurrence) associated with one or a combination of the item identifier, terminal identifier, cashier identifier, coupon identifier, interrupt identifier, and/or tender type identifies the actual bottleneck.

In an embodiment, a combination of statistical analysis (as described above for problem transaction finder 115) and one or more trained machine-learning models 114 may be used to identify the problem transactions (where), the time slices within the transactions (when), and the bottlenecks within the time slices. Finder 115 maintains and continuously updates the metrics and ratios as new transactions are processed by terminals 130 for a retailer and passes the model or average time metrics, normalized rations for calendar day, time of day, and day of week, and the time and identifier stamped transaction details to model 114 as input data. The expected output that model 114 was trained to produce as output is an indication if a bottleneck was identified, the time slice or slices (if more than one) within the transaction that a bottleneck was observed, and the corresponding pattern and identifiers associated with the time slice that is associated with the bottleneck.

The problem transactions, the time slices for the bottlenecks within each problem transaction, and the pattern and identifiers for the bottleneck within the time slice(s) are flagged and stored by report/alert manager 113 on behalf of the retailer.

Dynamic alerts can be pushed by report/alert manager 113 to the retailer using an Application Programming Interface (API) to report interface 124 for specific bottlenecks based on retailer-defined criteria (for example, report a bottleneck in real time as an alert when the bottleneck deviates from an average processing time by X%. Moreover, customized periodic reports or on-demand reports can be generated for all or custom combinations of the bottlenecks via interface 124. Interface 124 includes a search criteria or report criteria input and selection screen, which permits a retailer to define and receive reports on specific identifiers (terminals, cashiers, coupons, tender types, item codes) or combination of identifiers within an optional retailer defined period of time.

Moreover, interface 124 may allow the retailer to provide an average hourly cost associated with staff, such that reports, and alerts can calculate an average loss of time and cost associated with each bottleneck or set of bottlenecks within a given period of time. Report/alert manager 113 can calculate the lost hours based on the deviation in actual time for the bottleneck and the corresponding average time for that time slice expected and can calculate the expense by multiplying the lost hours by the retailer-provided average hourly cost of staff. In this way, system 100 can give a retailer a tangible loss in staff hours and expense associated with each bottleneck or retailer-defined custom set of multiple bottlenecks with reach report and/or alert.

In an embodiment, report/alert manager 113 maintains a real-time dashboard that is rendered and dynamically available within a screen of interface 124 as a retailer monitors ongoing transactions occurring within a store on terminals 130. The dashboard can show bottlenecks detected for the store as a whole, by terminal 130, by cashier, by item code, by coupon code, and by tender types and assign a lost time and value with the dynamically updated screen. Components of the dashboard may be clicked to get finer-grain details and/or to generate a report with or without any supplemental retailer criteria provided by the retailer through interface 124.

In an embodiment, system 100 is provided as a Software-as-a-Service (SaaS) through cloud 110 to retail server 120 and terminal 130 using an Application Programming Interface (API) from and to report/alert manager 113 to transaction manager 133 and report interface 124.

.In an embodiment, transaction terminal 130 is a Point-Of-Sale (POS) terminal, a Self-Service Terminal (SST), an Automated Teller Machine (ATM), or a kiosk.

In an embodiment, report/alert manager 113, model 114, and problem transaction finder 115 may be subsumed into and executed on retailer server 120.

In an embodiment, transaction manager 123 and/or report interface 124 may be subsumed into and executed on cloud/server 110.

In an embodiment, problem transaction finder 113 can be run in a batch mode at the end of each day or other preconfigured intervals of time, in which the transaction logs for the interval of time are provided and a report is generated and pushed to report interface 124 that identifies the problem transactions and each identified bottleneck along with a calculated lost time and expense associated with each bottleneck identified and for the interval as a whole. Report/Alert manager 113 may also link identified bottlenecks in a given problem transaction to video clips of security video for retrieval and for visually auditing by the retailer through interface 124 (here video during the transactions are also streamed to report/alert manager 113 for indexing and linking by manager 113 and subsequent access through interface 124.

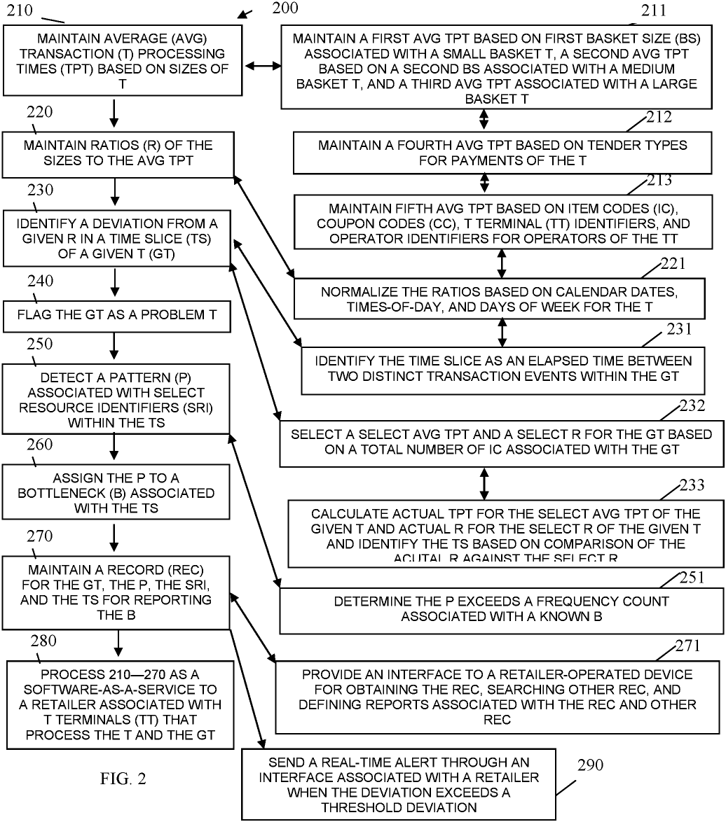

The above-referenced embodiments and other embodiments are now discussed with reference to FIG. 2.

FIG. 2 is a diagram of a method 200 for detecting, analyzing, and reporting transaction bottlenecks, according to an example embodiment. The software module(s) that implements the method 200 is referred to as a “transaction bottleneck identifier.” The transaction bottleneck identifier is implemented as executable instructions programmed and residing within memory and/or a non-transitory computer-readable (processor-readable) storage medium and executed by one or more processors of one or more devices. The processor(s) of the device(s) that executes the transaction bottleneck identifier are specifically configured and programmed to process the transaction bottleneck identifier. The transaction bottleneck identifier has access to one or more network connections during its processing. The connections can be wired, wireless, or a combination of wired and wireless.

In an embodiment, the device that executes the transaction bottleneck identifier is cloud 110. In an embodiment, the device that executes transaction bottleneck identifier is server 110.

In an embodiment, the transaction bottleneck identifier is all of, or some combination of report/alert manager 113, model(s) 114, and/or problem transaction finder 115.

At 210, transaction bottleneck identifier maintains average transaction processing times based on sizes (basket sizes or total number of items processed) of transactions.

In an embodiment, at 211, the transaction bottleneck identifier maintains a first average transaction processing time based on a first basket size associated with a small basket transaction, a second average transaction processing time based on a second basket size associated with a medium basket transaction, and a third average transaction processing time based on a third basket size associated with a large basket transaction.

In an embodiment of 211 and at 212, the transaction bottleneck identifier maintains a fourth average transaction processing time based on tender types for payments of the transactions.

In an embodiment of 212 and at 213, the transaction bottleneck identifier maintains multiple fifth average transaction processing times based on item codes, coupon codes, terminal identifiers for transaction terminals 130, and operator identifiers for operators of the transaction terminals 130 (cashier identifiers when terminals 130 are operating POS terminals and a generic customer identifier for all customers performing self-checkouts on SSTs).

At 220, the transaction bottleneck identifier maintains ratios of the sizes to the average transaction processing times, e.g., small basket size / average small basket transaction processing time, etc.

In an embodiment of 213 and 220, at 221, the transaction bottleneck identifier normalizes the ratios based on calendar dates, times of day, and days of week for the transactions. For example, a Saturday morning between 10 am and noon is typically heavy with customer traffic, such that the ratio is weighted to reflect a difference between a high customer traffic time versus low or medium customer traffic conditions.

At 230, the transaction bottleneck identifier identifies a deviation from a given ratio in a time slice of a given transaction.

In an embodiment of 221 and 230, at 231, the transaction bottleneck identifier identifies the time slice as an elapsed time between two distinct transaction events within the given transaction. An event is a start of the transaction, identification of an item, an item weight, payment initiated, payment type selected, coupon provided for redemption, coupon identified, an interrupt, etc.

In an embodiment, at 232, the transaction bottleneck identifier selects a select average transaction processing time and a select ratio for the given transaction based on a total number of item codes (transaction basket size) associated with the given transaction.

In an embodiment of 232 and at 233, the transaction bottleneck identifier calculates an actual transaction processing time for the select average transaction processing of the given transaction and further calculates an actual ratio for the select ratio of the given transaction and identifies the time slice based on a comparison of the actual ratio against the select ratio to identify a deviation that exceeds a predefined time deviation.

At 240, the transaction bottleneck identifier flags the given transaction as a problem transaction.

At 250, the transaction bottleneck identifier detects a pattern associated with select resource identifiers or combination of resource identifiers within the time slice.

In an embodiment, at 251, the transaction bottleneck identifier determines that the pattern matched in the given transaction is associated with a frequency count that linked to a known bottleneck.

At 260, the transaction bottleneck identifier assigns the pattern to a bottleneck associated with the time slice in the given transaction.

At 270, the transaction bottleneck identifier maintains a record for the given transaction, the pattern, the select resource identifiers, and the time slice for reporting the bottleneck.

In an embodiment, at 271, the transaction bottleneck identifier provides an interface 124 to a retailer-operated device 120 for obtaining the record, searching other records, and defining reports associated with the record and other records.

In an embodiment, at 280, the transaction bottleneck identifier is provided and processed as a SaaS to a retailer associated with transaction terminals 130 that process the transactions and the given transaction.

In an embodiment, at 290, the transaction bottleneck identifier sends a real-time alert through an interface 124 associated with a retailer when the deviation exceeds a threshold deviation.

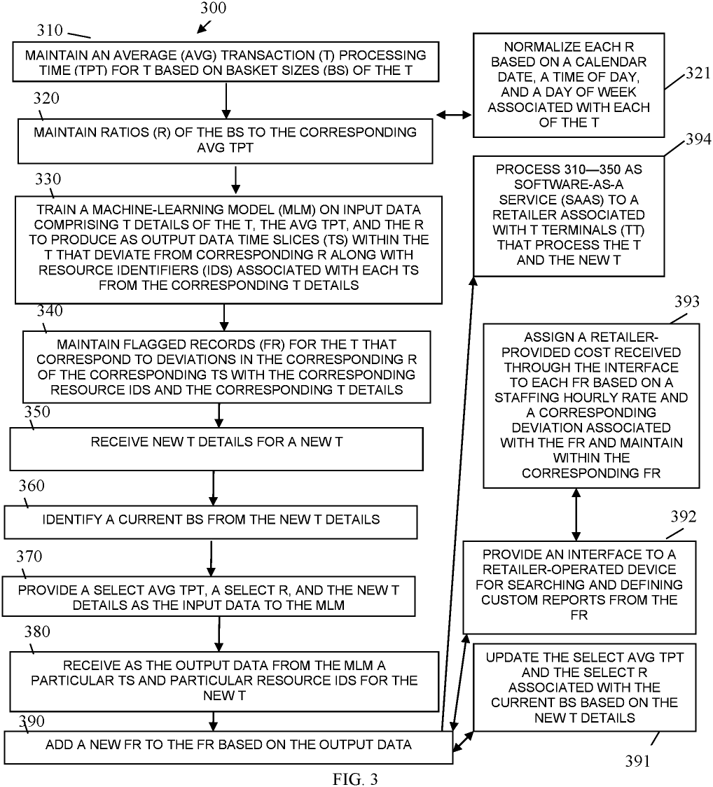

FIG. 3 is a diagram of another method 300 for detecting, analyzing, and reporting transaction bottlenecks, according to an example embodiment. The software module(s) that implements the method 300 is referred to as a “bottleneck detector and reporter.” The bottleneck detector and reporter is implemented as executable instructions programmed and residing within memory and/or a non-transitory computer-readable (processor-readable) storage medium and executed by one or more processors of one or more devices. The processor(s) of the device(s) that executes the bottleneck detector and reporter are specifically configured and programmed to process the bottleneck detector and reporter. The bottleneck detector and reporter has access to one or more network connections during its processing. The network connections can be wired, wireless, or a combination of wired and wireless.

In an embodiment, the device that executes the bottleneck detector and reporter is cloud 110. In an embodiment, the device that executes the bottleneck detector and reporter is server 110.

In an embodiment, the bottleneck detector and reporter is all of, or some combination of report/alert manager 113, model(s) 114, problem transaction finder 115, and/or method 200.

The bottleneck detector and reporter presents another and, in some ways, enhanced processing perspective from that which was discussed above with the method 200 of the FIG. 2.

At 310, the bottleneck detector and reporter maintains an average transaction processing time for transaction based on basket sizes of the transactions.

At 320, the bottleneck detector and reporter maintains ratios of the basket sizes to the corresponding average transaction processing times.

In an embodiment, at 321, the bottleneck detector and reporter normalizes each ratio based on a calendar date, a time of day, and a day of week associated with each of the transactions.

At 330, the bottleneck detector and reporter trains a MLM 114 on input data comprising transaction details for the transactions, the average transaction processing times, and the ratios to produce as output data time slices within the transactions that deviate from corresponding ratios along with resource identifiers associated with each time slice from the corresponding transaction details. Again, resource identifiers can include terminal identifiers, operator identifiers, item code/identifiers, coupon identifiers, payment tender types, terminal peripheral identifiers (e.g., scanner identifier, printer identifier, media dispensary identifier, etc.), etc.

At 340, the bottleneck detector and reporter maintains flagged records for the transaction that correspond to deviations in the corresponding ratios of the corresponding time slices with the corresponding resource identifiers and the corresponding transaction details.

At 350, the bottleneck detector and reporter receives new transaction details for a new transaction.

At 360, the bottleneck detector and reporter identifies a current basket size from the new transaction details.

At 370, the bottleneck detector and reporter provides a select average transaction processing time based on the current basket size, a select ratio based on the current basket size, and the new transaction details as the input data to the MLM 114.

At 380, the bottleneck detector and reporter receives as the output data from the MLM 114 a particular time slice and particular resource identifiers for the new transaction.

At 390, the bottleneck detector and reporter adds a new flagged record to the flagged records based on the output data.

In an embodiment, at 391, the bottleneck detector and reporter updates the select average transaction processing time and the select ratio associated with the current basket size based on the new transaction details of the new transaction.

In an embodiment, at 392, the bottleneck detector and reporter provides an interface 124 to a retailer-operated device 120 for searching and defining custom reports from the flagged records.

In an embodiment of 392 and at 393, the bottleneck detector and reporter assigns a retailer-provided cost received through the interface 124 to each flagged record based on a staffing hourly rate and a corresponding deviation associated with the flagged record and maintains the cost within the corresponding flagged record. This allows the retailer to directly attribute lost time and expense of the retailer associated with the bottleneck in each flagged record.

In an embodiment, at 394, the bottleneck detector and reporter is provided and processed as a SaaS to a retailer associated with transaction terminals 130 that process the transactions and the new transaction within a retail store of the retailer.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
maintaining average transaction processing times based on sizes of transactions;
maintaining ratios of the sizes to the average transaction processing times;
identifying a deviation from a given ratio in a time slice of a given transaction;
flagging the given transaction as a problem transaction;
detecting a pattern associated with select resource identifiers within the time slice;
assigning the pattern to a bottleneck associated with the time slice; and
maintaining a record for the given transaction, the pattern, the select resource identifiers, and the time slice for reporting the bottleneck.

2. The method of claim 1 further comprising, processing the method as a Software-as-a-Service (SaaS) to a retailer associated with transaction terminals that process the transactions and the given transaction.

3. The method of claim 1 further comprising, sending a real-time alert through an interface associated with a retailer when the deviation exceeds a threshold deviation.

4. The method of claim 1, wherein maintaining the average transaction processing times further includes maintaining a first average transaction time based on a first basket size associated with a small basket transaction, a second average transaction processing time based on a second basket size associated with a medium basket transaction, and a third average transaction processing time based on a large basket size associated with a large basket transaction.

5. The method of claim 4, wherein maintaining the first average transaction processing size further includes maintaining a fourth average transaction processing time based on tender types for payments processed with the transactions.

6. The method of claim 5, wherein maintaining the fourth average transaction processing time further includes maintaining fifth average transaction processing times based on item codes for items of the transactions, coupon codes for coupons redeemed with the transaction, and operator identifiers for operators of transaction terminals that processed the transactions.

7. The method of claim 6, wherein maintaining the ratios further includes normalize the ratios based on calendar dates, times-of-day, and days of week for the transactions.

8. The method of claim 7, wherein identifying further includes identify the time slice as an elapsed time between two distinct transaction events within each transaction.

9. The method of claim 1, wherein identifying further includes selecting select averages and select ratios for the given transaction based on a total number of item codes associated with the given transaction.

10. The method of claim 9, wherein selecting further includes calculating actual transaction processing times for the select averages of the given transaction and actual ratios for the select ratios of the given transaction and identifying the deviation in the time slice based on comparing the actual ratios against the select ratios .

11. The method of claim 1, wherein detecting further includes determining the pattern exceeds a frequency count associated with a known bottleneck.

12. The method of claim 11, wherein maintaining the record further includes providing an interface to a retailer-operated device for obtaining the record, searching other records, and defining reports associated with the record and other records.

13. A method, comprising:
maintaining average transaction processing times for transactions based on basket sizes of the transactions;
maintaining ratios of the the basket sizes to the corresponding average transaction processing times;
training a machine-learning module on input data comprising transaction details of the transactions, the average transaction processing times, and the ratios to produce as output time slices within the transactions that deviate from corresponding ratios along with resource identifiers associated with each time slice from the corresponding transaction details;
maintaining flagged records for the transactions that correspond to deviations in the corresponding ratios of the corresponding time slices with the corresponding resource identifiers and the corresponding transaction details;
receiving new transaction details for a new transaction;
identifying a current basket size from the new transaction details;
providing a select average transaction processing time and a select ration along with the new transaction details as the input data to the machine-learning model;
receiving as the output data from the machine-learning model a particular time slice and particular resource identifiers; and
adding a new flagged record to the flagged records based on the output data.

14. The method of claim 13 further comprising, updating the select average transaction processing time and the select ratio associated with the current basket size based on the new transaction details.

15. The method of claim 13 further comprising, providing an interface to a retailer-operated device for searching and defining custom reports from the flagged records.

16. The method of claim 15 further comprising, assigning a retailer-provided a cost received through the interface to each flagged record based on a staffing hourly rate and a corresponding deviation associated with the corresponding flagged record and maintain the cost within the corresponding flagged record.

17. The method of claim 13 further comprising, processing the method as a Software-as-a-Service (SaaS) to a retailer associated with a transaction terminal that processes the transactions and the new transaction.

18. The method of claim 13, wherein maintaining the ratios further includes normalizing each ratio based on a calendar date, a time of day, and a day of week associated with each of the transactions.

19. A system, comprising:
a cloud server comprising at least one processor and a non-transitory computer-readable storage medium;
the non-transitory computer-readable storage medium comprises executable instructions;
the executable instructions when provided to and executed by the at least one processor from the non-transitory computer-readable storage medium cause the at least one processor to perform operations comprising:
maintaining an average transaction processing time by basket sizes of transactions and a ratio of each basket size to the corresponding average transaction processing time;
maintaining second average transaction processing times by resource identifiers associated with the transactions;
determining when a given transaction is a problem transaction based on transaction details of the given transaction and a deviation within the transaction details from the corresponding average transaction processing time or one of the corresponding second average transaction processing times;
flagging a time slice in the given transaction associated with the deviation;
identifying a pattern in the time slice based on the resource identifiers that correspond to the time slice;
assigning the time slice to a bottleneck based on the pattern;
creating a new record that comprises the transaction details, the deviation, the time slice, the pattern, the bottleneck, and the resource identifiers that correspond to the time slice; and
providing an interface to a retailer-operated device to search for the new record and other records associated with other bottlenecks, to define reports, and to define alerts based on the bottleneck and the other bottlenecks.

20. The system of claim 19, wherein the executable instructions are accessible as a Software-as-a-Service (SaaS) to a retailer server associated with a retailer that processes the transactions and the given transaction on one or more transaction terminals of the retailer at a retail store.
